(19) United States
(12) Patent Application Publication
(10) Pub. No.: US 2014/0281475 A1
(43) Pub. Date: Sep. 18, 2014

(54) METHOD AND SYSTEM FOR PROVISIONING A COMPUTING DEVICE BASED ON LOCATION

(71) Applicant: OpenPeak Inc., Boca Raton, FL (US)

(72) Inventor: Charles Peter Schultz, North Miami Beach, FL (US)

(21) Appl. No.: 14/054,906

(22) Filed: Oct. 16, 2013

Related U.S. Application Data
(60) Provisional application No. 61/798,151, filed on Mar. 15, 2013.

(51) Int. Cl. G06F 9/445; G06F 9/44

(52) U.S. Cl. CPC G06F 9/44505; G06F 9/4448
USPC 713/100

(57) ABSTRACT

A method and system for provisioning a computing device based on location is disclosed herein. The computing device may be provisioned with first content based on a first location. The method includes the step of detecting a first change in the location of the computing device such that the computing device transitions from the first location to a second location. The method also includes the step of—in response to the detection of the first change in the location—identifying second content based on the second location. As an example, the second content may be at least partially based on the customs of the second location. In addition, the method also includes the step of provisioning the computing device with the second content such that the computing device is configured to at least partially operate in accordance with the customs of the second location.

### CROSS-REFERENCE TO RELATED APPLICATIONS

This patent application claims priority to U.S. Patent Application No. 61/798,151, filed on Mar. 15, 2013, which is herein incorporated by reference in its entirety.

### FIELD OF TECHNOLOGY

The present description relates to systems and methods for provisioning computing devices, and in particular, provisioning based on location.

### BACKGROUND

A user in a company, enterprise, or other group may be assigned a computing device to perform business related tasks or other functions. The computing device may be provisioned with content based on the location of the user and the customs of the location. For example, an application installed on the computing device may be configured to operate according to certain laws of the location. As such, when the computing device is provisioned to operate in a first location, it may not be able to operate within the customs of a second location without being re-provisioned or reconfigured in some manner.

A user of a computing device may travel to a different location, for example on a business trip, and may need to use the computing device to perform job related duties or other tasks. As it may be important, or even mandatory, that the computing device operate according to the customs of its location, there is a need for provisioning of content based on location.

### SUMMARY

A method of provisioning a computing device based on location is disclosed herein. The computing device may be provisioned with first content based on a first location. The method can include the steps of detecting a first change in the location of the computing device such that the computing device transitions from the first location to a second location, and in response to the detection, identifying second content based on the second location. In one arrangement, the second content may be at least partially based on the customs of the second location. As an example, the second content may include an application, data, or a setting that enables the computing device to operate according to a language associated with the second location. As another example, the second content may also include an application, data, or a setting that enables the computing device to operate according to a labor-related custom, a financial-related custom, or a currency associated with the second location.

The method may also include the step of provisioning the computing device with the second content such that the computing device is configured to at least partially operate in accordance with the customs of the second location. In one embodiment, provisioning the computing device with the second content may include installing or uninstalling applications from the computing device, adding or removing data from the computing device, or modifying settings on the computing device. Furthermore, provisioning of the computing device with the second content may occur before, during, or after the detection of the first change in the location.

The method can further include the step of detecting a second change in the location of the computing device such that the computing device transitions from the second location back to the first location. Furthermore, the method may include the steps of—in response to the detection of the second change in location—making the second content unavailable to the computing device and provisioning the computing device with the first content. As such, making the second content unavailable or provisioning the computing device with the first content may occur before, during, or after the detection of the second change in the location.

In addition, the method may also include the steps of recording data relating to the first content while the computing device is provisioned with the second content and applying the recorded data to the computing device in response to the detection of the second change in the location. The method may also include the step of storing a tag that associates the second location with the second content.

A method of location-based provisioning of a computing device at a back-end management unit is also disclosed herein. The computing device may be provisioned with first content based on a first location. The method can include the step of detecting, at the back-end management unit, a first change in the location of the computing device such that the computing device transitions from the first location to a second location. In one arrangement, the detection of the first change in the location may be performed with the use of location service coordinates, information from a communication network accessible to the computing device, or information from a social network or a scheduling tool.

The method may also include the step of—in response to the detection—generating a first provision notification associated with second content based on the second location. In one arrangement, the second content may be at least partially based on the customs of the second location. In addition, the method can also include the step of forwarding the first provision notification to the computing device to enable provisioning of the computing device with the second content. In one embodiment, provisioning of the computing device with the second content may include modifying an application, data, or a setting at the computing device such that the computing device is configured to operate according to a language associated with the second location.

Furthermore, the method may also include the step of detecting, at the back-end management unit, a second change in the location of the computing device such that the computing device transitions from the second location back to the first location. In addition, the method may include the step of—in response to the detection of the second change in the location—generating a second provision notification associated with the second change in the location. The method may also include the step of forwarding the second provision notification to the computing device to enable provisioning of the computing device such that the computing device no longer has access to at least a portion of the second content. In one arrangement, forwarding the second provision notification may further enable restoration of the first content or access to the first content at the computing device.

A system supporting location-based provisioning is also disclosed herein. The system may include an interface that is configured to transmit and receive signals. The system may further include a location detector that is communicatively coupled to the interface and may be configured to detect a first change in the location of a computing device from a first location to a second location. In one arrangement, the location detector may be configured to detect the first change in the location of the computing device using location service coordinates, network information, or information from a social network or scheduling tool.

The system may also include a processing unit communicatively coupled to the interface and to the location detector. The processing unit may be configured to—in response to the first change in the location—identify second content based on the second location. In one embodiment, the second content may include an application, data, or a setting that enables the computing device to operate according to a language associated with the second location. The processing unit may be further configured to cause the computing device to be provisioned with the second content to enable the computing device to operate at least partially according to the customs of the second location.

In one arrangement, the location detector may be further configured to detect a second change in the location of the computing device from the second location back to the first location. In addition, the processing unit may be further configured to—in response to the second change in the location—cause the computing device to be provisioned such that the computing device no longer has access to at least some portion of the second content and such that the computing device has access to at least some portion of the first content.

The system may also include a first memory unit that is communicatively coupled to the processing unit and that is configured to store a tag that associates the second location with the second content. The system may also include a second memory unit that is configured to store data related to the first content obtained while the computing device is provisioned with the second content.

### BRIEF DESCRIPTION OF DRAWINGS

The accompanying drawings, which are incorporated herein and form part of the specification, illustrate embodiments of the subject matter described herein and, together with the description, further serve to explain the principles of such subject matter and to enable a person skilled in the relevant art(s) to make and use the subject matter.

FIG. 1 illustrates an example of a system that is capable of supporting location-based provisioning among computing devices.

FIG. 2 illustrates an example of a computing device.

FIG. 3 illustrates an example of a back-end management unit.

FIG. 4 illustrates an example of a method that can be used to perform location-based provisioning among computing devices.

FIG. 5 illustrates an example of a purchasing application operating on a computing device, provisioned differently according to location.

FIG. 6 illustrates an example of a translation application operating on a computing device, provisioned differently according to location.

FIG. 7 illustrates an example of a payroll application operating on a computing device, provisioned differently according to location.

Applicants expressly disclaim any rights to any third-party trademarks or copyrighted images included in the figures. Such marks and images have been included for illustrative purposes only and constitute the sole property of their respective owners.

The features and advantages of the embodiments herein will become more apparent from the detailed description set forth below when taken in conjunction with the drawings, in which like reference characters identify corresponding elements throughout. In the drawings, like reference numbers generally indicate identical, functionally similar, and/or structurally similar elements.

### DETAILED DESCRIPTION

The following detailed description refers to the accompanying drawings that illustrate exemplary embodiments; however, the scope of the present claims is not limited to these embodiments. Thus, embodiments beyond those shown in the accompanying drawings, such as modified versions of the illustrated embodiments, may nevertheless be encompassed by the present claims.

References in the specification to “one embodiment,” “an embodiment,” “an example embodiment,” “one arrangement,” “an arrangement” or the like, indicate that the embodiment or arrangement described may include a particular feature, structure, or characteristic, but every embodiment may not necessarily include the particular feature, structure, or characteristic. Moreover, such phrases are not necessarily referring to the same embodiment or arrangement. Furthermore, when a particular feature, structure, or characteristic is described in connection with an embodiment or arrangement, it is submitted that it is within the knowledge of one skilled in the art to implement such feature, structure, or characteristic in connection with other embodiments or arrangements whether or not explicitly described.

Several definitions that apply throughout this document will now be presented. The term “exemplary” as used herein is defined as an example or an instance of an object, apparatus, system, entity, composition, method, step or process. The term “communicatively coupled” is defined as a state in which two or more components are connected (either directly or indirectly) such that communication signals are able to be exchanged between the components on a unidirectional or bidirectional (or multi-directional) manner, either wirelessly, through a wired connection or a combination of both. A “computing device” is defined as a component that is configured to perform some process or function for a user and includes both mobile and non-mobile devices. A “network” is defined as a collection of hardware and software components that support and facilitate local-area, wide-area (or both) communications between any suitable number of devices. The terms “computer program medium” and “computer readable medium” are defined as one or more non-transitory components that are configured to store instructions that are to be executed by a processing unit.

An “application” is defined as a program or programs that perform one or more particular tasks on a computing device. Examples of an application include programs that may present a user interface for interaction with a user or that may run in the background of an operating environment that may not present a user interface while in the background. The term “content” is defined as one or more applications, settings, privileges, configurations or policies that may be applied to a particular computing device. The term “privilege” is defined as a level of access, management, control or authority over content or other services associated with a computing device. The term “access” is defined as the right, ability or permission to perform some act or to obtain or receive data. The term “provision” is defined as an act, process or state that can affect content of a computing device, the content to which the computing device has access or the ability of the computing device to communicate with other components, such as other devices or servers or components of a network, and may also affect settings related to such communication. The term “settings” is defined as one or more characteristics or a state or condition of a computing device or component that describes or controls the capabilities, functionality, appearance, or the like of the computing device or component. The settings may be under the control of one or more persons, one or more components, or one or more applications.

The term “operating system” is defined as a collection of software components that directs a computing device's operations, including controlling and scheduling the execution of other programs and managing storage, input/output and communication resources. A “processing unit” is defined as one or more components that execute sets of instructions, and the components may be separate from one another or part of one whole unit and may even be located in different physical locations. The term “memory” or “memory element” is defined as one or more components that are configured to store data, either on a temporary or persistent basis. In addition, memory may include a combination of removable, permanent, or semi-permanent components. An “interface” is defined as a component or a group of components that enable(s) a device to communicate with one or more different devices, whether through hard-wired connections, wireless connections or a combination of both. A “graphical display” is defined as a component or group of components that enable(s) a device to display items such as information, pictures, icons, or the like such that the items can be viewed or sensed by a person or a device. A “transceiver” is defined as a component or a group of components that transmit signals, receive signals or transmit and receive signals, whether wirelessly or through a hard-wired connection or both.

The term “customs” can refer to the laws, rules, social norms, language(s), accepted business practices, traditions, or the like, that are normally recognized and followed in a location. The term “language” may refer to a collection of words, grammatical rules, syntax, spelling conventions, pronunciations, dialects, or the like, as used or understood by a community of people, a region or an organization.

As noted above, a user of a computing device may operate that device in a first location but may be required to travel to a second location, for example, on a business trip to a customer site. At least some portion of the computing device may not be compatible with the customs of the new or second location.

To alleviate this issue, a method and system for provisioning a computing device based on location is described herein. The computing device may be provisioned with first content based on a first location. A first change in the location of the computing device can be detected such that the computing device transitions from the first location to a second location. In response to the detection of the first change in the location, second content based on the second location can be identified, and the second content may be at least partially based on the customs of the second location. The computing device may be provisioned with the second content such that the computing device is configured to at least partially operate in accordance with the customs of the second location.

Thus, the computing device can easily be provisioned with second content that can enable a user of the device to operate the device based on the customs of the new location. In addition, when the computing device returns to the first location, the device may be re-provisioned with the first content, and the second content can be removed. This process can allow for efficient operation of the computing device, particularly when that device is involved in international travel.

Referring to FIG. 1, an example of a system 100 for provisioning a computing device based on location is shown. The system 100 can include a network 120, a back-end management unit 125, and one or more computing devices 105, 110, 115. The system 100 is not meant to be limited to the number of networks, management units or computing devices shown in the diagram, as any suitable number of components may be part of the system 100. Furthermore, the computing devices 105, 110, 115 may be capable of operating at multiple locations. As an example, the computing device 105 is representatively shown operating in a first and a second location. In one embodiment, the first location can be a home location of a user of the computing device 105, while the second location may be a location to which the user travels on a temporary basis. In FIG. 1, the computing device 105 in the second location is shown with a dotted line configuration to reflect such a temporary nature. This embodiment, however, is not meant to be limiting, as any suitable locations, and any number of locations, can be supported by the system 100.

The back-end management unit 125 may be configured to manage or oversee tasks associated with or facilitate the operations of the computing devices 105, 110, 115, the network 120, or other components within or outside of the system 100. As an example, the back-end management unit 125 may detect changes in the location of the computing device 105 and may also define, execute, manage or enable provisioning of the computing device 105, in response to changes in location or other events. As shown in FIG. 1, the back-end management unit 125 may be communicatively coupled to the computing devices 105, 110, 115 or to the network 120. Although not explicitly shown, the back-end management unit 125 may also be communicatively coupled to entities outside of the system 100.

The network 120 may be comprised of any suitable combination of components that enables wireless or wired communications, or both. The network 120 may be a single network or may be comprised of multiple networks working together to perform networking tasks, as known to those skilled in the art. Although not explicitly shown in FIG. 1, the network 120 may be communicatively coupled to any or all of the computing devices 105, 110, 115 or to entities outside of the system 100, such as external networks or desktop computers or the like.

It should be noted that the components of the system 100 may communicate with each other and with entities outside of the system 100 through direct or indirect connections. As an example of an indirect connection, the network 120 may communicate with the computing device 105 indirectly by providing information directly to the back-end management unit 125 for forwarding to the computing device 105. As another example of an indirect connection, a communication path between the back-end management unit 125 and an external database may include a router, gateway or firewall located just before the external database. In addition, although not explicitly shown in FIG. 1, components of the system 100 may communicate in a manner that does not utilize the network 120. In one example, any of the computing devices 105, 110, 115 can be communicatively coupled to one another through “off-network” or asynchronous connections. As another example, any of the computing devices 105, 110, 115 can be communicatively coupled to the back-end management unit 125 through a connection other than the network 120. Although these examples of indirect and off-network connections serve to illustrate the principles, they are not meant to be limiting.

Referring to FIG. 2, a block diagram of an example of a computing device 105 is shown. The computing device 105 may include a processing unit 200, and may further include a memory unit 210, a database 215, one or more inputs 225 and a keyboard 230, any or all of which may be communicatively coupled to the processing unit 200. The memory unit 210 may be a single memory unit, or may be comprised of multiple memory units that may operate independently or jointly. The inputs 225 may include, for example, a mouse, a touch screen, a microphone, or any other suitable component that enables a user to provide input to the computing device 105. The computing device 105 may also include a graphical display 235, which may present a user with data, information, settings or the like, and may be communicatively coupled to the processing unit 200. The computing device 105 may further include an operating system and any suitable type of abstraction layers to enable applications that may be installed on the device 105 to interact with the components described here and other elements of the device 105. To enable the computing device 105 to communicate with other components, the device 105 may also include an interface 205. As an example, there may be multiple interfaces 205, each of which may be configured to support either wired or wireless communications with a variety of components, such as other computing devices, external networks, landline phones, desktop computers, or the like. The interfaces 205 can be configured to operate in accordance with various protocols.

The computing device 105 may also include a location detector 220, which may be configured to detect a location or a change in location of the computing device 105 during a past, present, or future time period. In addition, the location detector 220 may be enabled to detect other information related to location, such as the duration of time that the computing device 105 spends or has spent at a location, a historical log of the location of the computing device 105, or any other relevant data. For these and other purposes, the location detector 220 may be capable of receiving information, such as GPS coordinates, network information, scheduling information, or the like, as will be described and exemplified below. This information may be communicated to the location detector 220 from the interface 205, the processing unit 200, or any other source. In addition, such information may be stored at and retrieved from the memory 210, the database 215, or any other source internal or external to the system 100. Furthermore, the location detector 220 may be capable of communicating a location, a change in location, or other location information to the graphical display 235 (via the processing unit 200) for presentation to a user of the computing device 105.

Referring to FIG. 3, a block diagram of an example of a back-end management unit 125 is shown. The back-end management unit 125 may include a processing unit 300 and may further include an interface 305, a memory unit 310, and a database 315, any or all of which may be communicatively coupled to the processing unit 300. Such components as included in the back-end management unit 125 may be identical or similar to the counterpart components disclosed earlier for the computing device 105, in structure or in functionality, but should not be so limited, and any suitable components can be used. Like the computing device 105, the back-end management unit 125 may include an operating system and any suitable type of abstraction layers to enable applications that may be installed on the back-end management unit 125 to interact with the components described here and other elements of the back-end management unit 125.

In addition, the back-end management unit 125 may include a location detector 320, which may be configured to detect a location, a change in location, or other location information associated with any or all of the computing devices 105, 110, 115 during a past, present, or future time period. The location detector 320 may perform similar functionality in comparison to the location detector 220 included in the computing device 105, but is not meant to be so limited. As an example, the location detector 320 may be communicatively coupled to the processing unit 300, the interface 305, the memory 310, the database 315, or any other component, and may receive information (GPS coordinates, network information, scheduling information, or the like) from them for use in the location detection process. Furthermore, the location detectors 220 and 320 may operate independently, or may work together to perform detection operations.

Referring again to FIG. 3, the back-end management unit 125 may be communicatively coupled to any number of remote databases 330, 335, 340 or to a cloud database 325. It should be noted that the subject matter described is not limited to the configuration shown in FIG. 3, as any number of remote databases or cloud databases may be communicatively coupled to the back-end management unit 125. In one embodiment, the remote database 330 or cloud database 325 may be configured to store content associated with one or more locations. The content may be forwarded to the back-end management unit 125, or to the computing device 105 or some other suitable component, to enable provisioning of the computing device 105. It should be noted that any or all of the remote databases 330, 335, 340 and the cloud database 325 may be in the same location or in different locations. In addition, the databases may be communicatively coupled to one another, and may also be configured to store content independently or jointly.

Furthermore, the databases are not limited to be under control of the company, group, or organization that controls components of the system 100 such as the back-end management unit 125. In fact, it is possible that databases owned and controlled by external entities, such as other companies or even competitors, may be used to store content. As an example, a software company may retain multiple international versions of a software package or application on a company database or repository accessible to customers, but controlled by the software company. As an example, a provisioning process for a user traveling abroad may include downloading the appropriate version of the package or application from that external database or repository. Virtually any entity may provide content to or maintain the databases 330, 335, 340 and the cloud database 325.

Referring to FIG. 4, a method 400 of provisioning computing devices based on location is shown. It is important to note that the method 400 may include additional or even fewer steps or processes in comparison to what is illustrated in FIG. 4. Moreover, the method 400 is not necessarily limited to the chronological order that is shown in FIG. 4. In describing the method 400, reference may be made to FIGS. 1-3, although it is understood that the method 400 may be practiced with any other suitable systems and components.

At step 405, a first change in location of a computing device 105, can be detected, and this change reflects the computing device 105 transitioning from a first location to a second location. At step 410, second content may be identified based on the second location.

The detection may be performed in any suitable manner at the computing device 105, at the back-end management unit 125, or jointly by the two. In addition, the description that follows regarding the detection of the first change in location may be applied to detection of any other change in location of the computing device 105.

In one embodiment, the term “detection,” as it may be applied to the detection of a change in location, may refer to the act of receiving notification that the location change has occurred, or otherwise learning or discovering that such a chance has happened or is happening. Such a notification may occur as part of a control message, a signaling message, a data message, or any suitable communication. As an example, the back-end management unit 125 may receive a message informing it that the computing device 105 has made the location change. In another example, the network 120 or some other component may inform the computing device 105 that the device 105 has entered a new location, as part of an initialization process during power up of the device 105 or when the device 105 registers with a new network 120.

In another embodiment, the location change can be detected using coordinates or other information from a location service, such as GPS. In another embodiment, the change in location may be detected using information from the network 120 or from any other network to which the computing device 105 is connected, has been connected, or will be connected, including a cellular phone network, a local area network, a Wi Fi network, or the like. Such information may include an “IP address,” network address, phone number, or any suitable identifier (permanent or temporary) associated with the computing device 105 or the network connection.

In another embodiment, the location change may be detected using information from a social networking service or a calendar, such as travel plans of the user. As an example, a user may record plans for a business trip in a calendar accessible to another party, such as a company calendar maintained by the user's employer, and location change(s) associated with the business trip may be detected in response. As another example, a user may announce on a social networking service plans to take a trip, stay at a hotel, visit an attraction, or attend an event, and location change(s) may be detected in response to this information. In yet another embodiment, the location change can be detected in response to a manual input step performed by the user or another person. For example, the user may manually inform a network administrator or another person that a location change has occurred or is occurring, or that a location change is planned at a future time.

It should be noted that the computing device 105 “transitioning” from the first location to the second location can refer to a simple change in presence from the first location to the second location or can refer to a period of time in which the computing device 105 travels between the first location and second location thus causing the change in location. As such, detection of the change in location may occur after the computing device 105 has transitioned to the second location, while the computing device 105 transitions to the second location, or before the computing device 105 has transitioned to the second location.

It should also be noted that the term “location” can refer to a domain, such as a city, county, state or country or the like, or can refer to any geographic region, but the term should not be restricted to refer to a contiguous geographic region. For example, location may also refer to two or more geographically separated regions in which the regions may be culturally similar or may have similar customs. Location can also refer to any arbitrarily defined zone or to any set of physical premises. As an example, location can refer to the physical space within a building in a corporate campus with several buildings in which the buildings may or may not be in close proximity. As another example, location can refer to the area within a certain radius of a fixed point. In another example, location can refer to a street address, a city name, or to the area specified by a certain postal code, commonly referred to as a “ZIP code.” Location may also refer to a location tagged in a social network in which the term “tagged” or “tag” is defined and exemplified elsewhere within this disclosure.

Location may also refer to a set of virtual boundaries, commonly known as a “geo-fence.” As another example, a location may refer to a virtual connection space, such as a space accessible through a Virtual Private Network (VPN), in which users with access to the space may or may not be in close proximity to one another. In the embodiments and examples disclosed herein, it should be further noted a second location may be based on a first location, and the second location may be characterized as a set of locations that excludes or is different from the first location. For example, a first location may refer to the area within a city, and a second location may refer to all areas not in the city. In the embodiments and examples disclosed herein, it should be understood that a user's presence in a location may be temporary or permanent.

As mentioned previously, second content based on the second location may be identified, and may be based at least partially on the customs of the second location. As described earlier, customs may include laws, rules, social norms, language(s), accepted business practices, traditions, or the like, that are normally recognized and followed in a location. Accordingly, the second content intended for the computing device 105, such as applications to be installed on the device 105 or provisions or settings at the device 105, may comply with laws, accepted business practices, or other customs of the second location.

In an example, a time-tracking application may need to be configured differently in multiple locations in order to operate in accordance with labor laws in those locations or based on the time zone of a particular location. In another example, applications for expense reporting or purchasing may need to be configured to operate in accordance with financial laws of the location or to use an accepted currency in the location. One such format for purchasing may be an electronic storefront in which applications can be electronically purchased. In another example, an application for performing a service may need to be configured differently in multiple locations in order to operate in accordance with laws of those locations, as such services may be illegal in one location and legal in another location. For example, some social networking applications may be banned or partially censored in certain locations, and these applications may be uninstalled, disabled or modified to comply with the laws of that location.

In another example, an application for performing a location-based service may need to be configured according to the physical infrastructure of the location, as the infrastructure of the location may or may not be capable of supporting the service. For example, some locations may not support broadband connections, and the communications stack for facilitating that type of communications may be disabled or otherwise suspended. In yet another example, an application may need to be configured to operate in accordance with language(s) of the location, including dialects of a language or variations in spelling of terms with similar meanings, like “color” and “colour.”

The identification of the second content may be performed by a network administrator, the user, or any other person, or may be automatically performed. For example, once the back-end management unit 125 detects the change in location, that unit 125 can identify or direct another component to identify the second content that is relevant to the new location. It should be noted that identification of the second content may occur before, during, or after the computing device 105 transitions to the second location.

Referring back to FIG. 4, in step 415 of the method 400, a first provision notification associated with the second content may be generated and forwarded to the computing device 105, and in step 420, the computing device 105 may be provisioned with the second content. In one embodiment, the provision notification may be generated at the back-end management unit 125 and may be forwarded to the computing device 105 through the interface 305. This embodiment, however, is not meant to be limiting, and the provision notification may be generated at or forwarded from any suitable component within or outside of the system 100.

In one arrangement, the provision notification may include a command that the computing device 105 be provisioned with certain types of content. In another arrangement, the provision notification may further include a provisioning process, which may include a set of steps for the computing device 105 to follow. In another arrangement, a tag (as will be explained below) or some other identifier may be included in the provision notification, and the tag may be referenced by the computing device 105 to receive a provisioning process. In yet another arrangement, the provision notification may include the second content, for instance, the source code of one or more applications to be installed on the device 105 as part of the provisioning process. In an example scenario, a company may, for enterprise management or other reasons, store applications or other data at the database 315 of the back-end management unit 125, on a cloud database 325, or a remote database 330 to be distributed to the computing device 105 or other devices for installation and use as needed.

In step 420, the computing device 105 may be provisioned with the second content. It should be noted that some or all of the aspects or steps described below for provisioning the computing device 105 with the second content may be applicable to provisioning the device 105 with other suitable content.

Provisioning with the second content may be performed by the computing device 105, the back-end management unit 125, jointly by the two, or by any other suitable component(s) inside or outside the system 100. The provisioning may include following a provisioning process, which may be included in the provision notification as described earlier or may be predetermined (for example, by a network administrator) and stored at the computing device 105 or at the back-end management unit 125 or at any suitable component within or external to the system 100. Alternatively, the necessary steps for provisioning may be determined in real-time by the computing device 105 or the back-end management unit 125, or by any person such as a network administrator or a user of the computing device 105.

Provisioning of the computing device 105 with the second content may include installing or uninstalling applications from the computing device 105, adding or removing data from the computing device 105, or modifying settings on the computing device 105. As the computing device 105 may already be provisioned with first content, provisioning with the second content may include removing, making unavailable, modifying, or replacing applications included in the first content. As an example, the use of a certain application, such as a recording application, may be legal and appropriate in the first location but illegal or inappropriate in the second location. As such, the application may need to be uninstalled or disabled when the device 105 is in the second location. As another example, a video playback application may be able to play a large amount of content in the first location, but copyright laws in the second location may be stricter than in the first location. The video playback application may need to be configured with additional editing or content filters in order to comply with the copyright laws in the second location. In yet another example, an application that searches through court cases may be configured quite differently in the first and second locations, as the two locations may have different policies on public access to such information.

Furthermore, provisioning with the second content may include modifying settings associated with the first content, or removing, making unavailable, modifying, or replacing a portion of or all of a set of data associated with the first content or the computing device 105. As an example, the settings on a video playback application may need to be modified such that the application is compatible with a regionally accepted video protocol followed in the second location. Differences between video protocols in the first and second locations may be similar to the regional differences that occur in the art of DVD's. In another example, a news application in a first location may be configured to monitor a first set of websites or other sources that generally provide appropriate news for the first location. In a second location, the same news application may be configured to monitor a second different set of websites or other sources that may provide news that is more relevant for the second location.

In addition, the provisioning of the computing device 105 with the second content may be further based on characteristics of the transition of the user of the device 105 between the first location and the second location. Such characteristics may include the rate of speed, altitude, direction, or the like of the computing device 105 during the transition, in which the transition may include the user traveling by any means of transportation, such as an airplane or a vehicle. In one embodiment, one or more steps of the provisioning process may be advanced or delayed in response to these or other characteristics of the transition. As an example, if it is determined that the user may arrive earlier than previously expected, necessary modifications to a web browser application on the device 105 may need to be expedited so that the user has uninterrupted web access upon arrival in the second location. In another embodiment, the provisioning may be based on a duration of time associated with the transition of the computing device 105 or the user from the first location to the second location. For example, one or more steps of the provisioning may be delayed until a predetermined amount of time has passed with respect to any time period associated with the transition. For example, the provisioning may occur after it is determined that the user has been in the second location for a certain duration of time. Thus, it can be useful to withhold the provisioning of second or different content until it is established that the affected user is actually in the new location. For example, a calendar application on the device 105 of a company employee who is traveling to a satellite location may be automatically updated with specific events and schedule information related to the company's satellite location. Such information may not be useful until the employee actually arrives at the satellite location.

In step 425, data relating to the first content may be recorded while the computing device 105 is provisioned with the second content. The data may be stored (or cached) locally within the computing device 105, at the back-end management unit 125, at any other component within the system 100, or on any suitable component external to the system such as the cloud database 325 or the remote database 330. For example, if applications that are associated with the first content are removed, disabled or otherwise unavailable while the computing device 105 is provisioned with the second content, then steps can be taken to ensure that any data that may be received that is related to such applications may be recorded and stored for later retrieval.

As an example, the first content may include a music identification application that records music and attempts to identify the song or artist by comparing the recorded music with an audio database. If the identification function violates copyright or other laws of the second location, for instance, provisioning with the second content may include modifying the application so that it can still record the music but cannot attempt the identification. Furthermore, such a set of data may be restricted so that it is made available for editing, deletion, viewing, or other use only when the computing device 105 or the user has returned to the first location or is once again provisioned with the first content. Thus, when the first content is restored to the computing device 105, the recorded data may be used to update, for example, applications associated with the first content. In the previous example, the music recorded while the device 105 was in the second location may be made available to the music identification application for identification of the song or artist when the device 105 returns to the first location and the application is restored once again with the identification functionality. Any particular data may be recorded during the time that the first content is removed. In fact, steps can be taken to perform a similar process for applications associated with the second content.

In step 430, a tag that associates the second content with the second location may be stored. The tag may be stored in the memory unit 210 of the computing device 105, the memory unit 310 of the back-end management unit 125, the cloud database 325, the remote database 330, or at any suitable location inside or outside of the system 100. The tag may serve as a reference to the second content or to a provisioning process associated with the second content or the second location. As an example, a company based in a first location that has operations in a second location may have previously determined, approved, and stored a provisioning process for the computing devices 105 of employees that travel to the second location. For instance, the computing device 105 of an employee in the finance department traveling to the second location may need to be reconfigured with a software change to a certain financial application to support the currency or accounting practices in the second location. As travel to the second location may be a frequent occurrence, it can be beneficial that an appropriate provisioning process be easily referenced with a simple tag, in contrast to determining the provisioning process from scratch each time an employee travels to the second location. In the previous example, the tag may be referenced as “finance department employee traveling to Europe” or similar, and the tag may include the necessary software change to the financial application or other information related to the provisioning process.

In step 435, a second change in location of the computing device 105, such that the computing device 105 transitions from the second location back to the first location, can be detected. In step 440, a second provision notification associated with the second change in location may be generated and forwarded to the computing device 105. In step 445, the second content may be made unavailable to the computing device 105, and the device 105 may further be provisioned with the first content.

The detection of the second change in location may be performed in any suitable manner, including, but not limited to, the techniques described earlier regarding the detection of the first change in location. In addition, detection of the second change in location may be performed at the computing device 105, at the back-end management unit 125, or jointly by the two. Furthermore, it is understood that the detection of the second change in location may occur before, during, or after the change occurs.

The second provision notification generated may be similar to the first provision notification in both functionality and purpose. That is, the second provision notification may be generated at or forwarded from any suitable component within or outside of the system 100, such as the back-end management unit 125. The second provision notification may instruct that the computing device 105 be provisioned with the first content, or may include a provisioning process or related tag for provisioning with the first content. In addition, the second provision notification may also include the first content.

It should be noted that the processes described in step 445, making the second content unavailable and provisioning with the first content, may include overlapping steps, and may be performed together or even as one step. Provisioning the device 105 with the first content may share similar aspects or actions to the step 420 of provisioning with the second content described earlier, but is not meant to be so limited, and any suitable process may be used to provision the device 105 with the first content. In one embodiment, provisioning with the first content may include actions that are opposite to, or reversals of, actions taken during the provisioning with the second content described above.

As an example, an accounting application that was reconfigured to operate according to the accepted accounting principles or other customs of the second location may be further reconfigured to once again operate according to the accepted accounting principles or customs of the first location, in response to the second change in location. As another example, a recording application that is legal in the first location but illegal in the second location may have been uninstalled or disabled during the first change in location. In response to the second change back to the first location, the application may be reinstalled or enabled.

Furthermore, the provisioning of the computing device 105 with the first content may be based on characteristics of the transition of the user of the device 105 from the second location back to the first location, or based on a duration of time spent in the first location. Accordingly, part or all of the provisioning with the first content may be advanced or delayed in response. In one particular example, provisioning the computing device 105 with the first content in relation to the second change in location can result in the device 105 being placed in the same or substantially the same state that the device 105 was in prior to the first change in location.

Provisioning the device 105 with the first content may be performed independently or jointly by any components inside or outside of the system 100, including the computing device 105 or the back-end management unit 125, and may be performed according to a provisioning process or in real-time. As part of provisioning the computing device 105 with the first content, applications, data, or settings may be installed, uninstalled, added, deleted, replaced, changed, or be made unavailable at the computing device 105. As an example, an application included in the second content may remain on the computing device 105 after the provisioning, but may be made inaccessible at the device 105 as a result of a permission change. As another example, a set of data obtained or altered while the computing device 105 was in the second location may be removed, or commonly referred to in the art as “wiped,” from the computing device in response to the user or the device 105 leaving the second location or entering the first location.

It is important to note that when the computing device 105 is provisioned again with the first content, the first content may be in a state that is identical to or different from the state in which it was in at the time of the first location change from the first location to the second location. Moreover, some (or even all) of the second content may remain with the computing device 105 when the device 105 moves back to the first location. It must also be stressed that the first content may be restored if the computing device 105 moves to a third location, which is different from the first location.

In step 450, the data recorded at the computing device 105 while the device 105 was provisioned with the second content may be applied to the device 105 in response to the detection of the second change in location. The recorded data may be used to update, for example, the applications associated with the first content previously unavailable while the device 105 was provisioned with second content. Applying the data may include forwarding the data to the device 105, forwarding a location identifier (such as a URL) at which the data may be accessed, lifting restrictions on or modifying permissions for access to the data, or any steps that enable the computing device 105 to access the data.

It should be pointed out that in the embodiments and examples described, the computing device 105 may be provisioned with content that includes applications not used for business purposes. As such, after any change in location of a computing device, such non-business applications may or may not remain installed on the computing device and may be unchanged in view of the location change. Examples of such applications include a compass application that indicates direction and an application that indicates the weather.

Several examples of the processes described herein will now be presented. In FIG. 5, a representation of a purchasing application 240 operating on the computing device 105 in two different locations is shown. To illustrate that the device 105 is operating in a first and a second location, the purchasing application 240 is referred to as “240a” and labeled with “first location” on the left-side version of the purchasing application 240. Similarly, the purchasing application 240 is referred to as “240b” and is labeled with “second location” on the right-side version of the purchasing application 240. Also, the purchasing application 240 is shown in a dotted configuration to reflect that the application 240 is operating in a new location different from the first location. Similar conventions will be followed in subsequent illustrations in FIGS. 6-7.

In FIG. 5, the purchasing application 240 operating in the first location shows a list of items presented by the purchasing application 240a, including a table and a desk, and allows the user to input a quantity of each item to be purchased. In the right-most column of the application 240a, a price is computed by the application 240 and is displayed in the currency of US dollars, which may be the generally accepted currency in the first location. When the user of the device 105 travels to a second location that generally accepts Euros as the currency, it may be beneficial to the user to see the price in Euros instead of US dollars, as seen in the purchasing application 240b. Provisioning the computing device 105 with content for the second location may include changing a setting in the purchasing application related to the currency output to be displayed. Alternatively, the provisioning may include installing a different version of the same purchasing application 240 on the computing device 105.

In FIG. 6, another example is shown, as a translation application 260 that operates in two or more different languages. In the top version of the translation application 260, the translation application 260a shows the English word “dog” to be translated. The output is given in Spanish, which may be the accepted language, or one of the accepted languages, of the first location. In the bottom version, the same translation application 260 is shown in operation. Again, the word “dog” is the input word to be translated from English, and in this case, the output is given in French, which may be the generally accepted language associated with the second location. As such, the translation application 260 may be provisioned to operate according to a generally accepted language in each location.

In FIG. 7, yet another example of location-based provisioning is shown. A payroll application 280 is used to generate a paystub record for an employee. The employee's gross pay is reduced by a number of deductions, which are added together to give a total deduction below the list of deductions. In the top version of the payroll application 280, operating in a first location, the payroll application 280a shows a list of deductions, including various taxes (federal, state, and medical) and corresponding percentages of gross pay for each deduction (20%, 5%, and 2%). In the bottom version, the payroll application 280b shows the same application 280 operating in a second location. The corresponding list of deductions for the payroll application 280b shows a different set of taxes in comparison to the first location (federal, payroll, and medical). In addition, the percentage for the medical tax is 3%, which is different than the 2% used in the first location. The taxes and percentages may be different at the two locations as a result of tax policies or laws, and accordingly, the payroll application may need to be configured differently in order to operate in the two locations.

While various embodiments have been described above, it should be understood that they have been presented by way of example only, and not limitation. It will be understood by those skilled in the relevant art(s) that various changes in form and details may be made therein without departing from the spirit and scope of the invention as defined in the appended claims. Accordingly, the breadth and scope of the present invention should not be limited by any of the above-described exemplary embodiments, but should be defined only in accordance with the following claims and their equivalents.

The flowchart and block diagrams in the figures illustrate the architecture, functionality, and operation of possible implementations of systems, methods and computer program products according to various embodiments. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

What is claimed is:

1. A method of provisioning a computing device based on location, wherein the computing device is provisioned with first content based on a first location, comprising:
detecting a first change in the location of the computing device such that the computing device transitions from the first location to a second location;
in response to the detection of the first change in the location, identifying second content based on the second location, wherein the second content is at least partially based on the customs of the second location; and
provisioning the computing device with the second content such that the computing device is configured to at least partially operate in accordance with the customs of the second location.

2. The method according to claim 1, further comprising:
detecting a second change in the location of the computing device such that the computing device transitions from the second location back to the first location; and
in response to the detection of the second change in the location, making the second content unavailable to the computing device and provisioning the computing device with the first content.

3. The method according to claim 2, further comprising recording data relating to the first content while the computing device is provisioned with the second content.

4. The method according to claim 1, wherein provisioning the computing device with the second content includes installing or uninstalling applications from the computing device, adding or removing data from the computing device, or modifying settings on the computing device.

5. The method according to claim 4, wherein the second content includes an application, data, or a setting that enables the computing device to operate according to a language associated with the second location.

6. The method according to claim 4, wherein the second content includes an application, data, or a setting that enables the computing device to operate according to a labor-related custom, a financial-related custom, or a currency associated with the second location.

7. The method according to claim 1, further comprising storing a tag that associates the second location with the second content.

8. The method according to claim 2, wherein the provisioning of the computing device with the first content or second content occurs before, during, or after the detection of the first or second change in the location.

9. A system supporting location-based provisioning, comprising:
an interface that is configured to transmit and receive signals;
a location detector that is communicatively coupled to the interface, wherein the location detector is configured to detect a first change in the location of a computing device from a first location to a second location; and
a processing unit that is communicatively coupled to the interface and to the location detector, wherein the processing unit is configured to:
in response to the first change in the location, identify second content based on the second location; and
cause the computing device to be provisioned with the second content to enable the computing device to operate at least partially according to the customs of the second location.

10. The system according to claim 9, wherein the location detector is further configured to detect a second change in the location of the computing device from the second location back to the first location and the processing unit is further configured to, in response to the second change in the location, cause the computing device to be provisioned such that the computing device no longer has access to at least some portion of the second content and such that the computing device has access to at least some portion of the first content.

11. The system according to claim 9, wherein the second content includes an application, data, or a setting that enables the computing device to operate according to a language associated with the second location

12. The system according to claim 9, further comprising a first memory unit that is communicatively coupled to the processing unit, wherein the first memory unit is configured to store a tag that associates the second location with the second content.

13. The system according to claim 9, further comprising a second memory unit that is communicatively coupled to the processing unit, wherein the second memory unit is configured to store data related to the first content obtained while the computing device is provisioned with the second content.

14. The system according to claim 9, wherein the location detector is configured to detect the first change in the location of the computing device using location service coordinates, network information, or information from a social network or scheduling tool.

15. The method according to claim 3, further comprising applying the recorded data to the computing device in response to the detection of the second change in the location.

16. A method of location-based provisioning of a computing device at a back-end management unit, wherein the computing device is provisioned with first content based on a first location, comprising:
detecting, at the back-end management unit, a first change in the location of the computing device such that the computing device transitions from the first location to a second location;
in response to the detection, generating a first provision notification associated with second content based on the second location, wherein the second content is at least partially based on the customs of the second location; and
forwarding the first provision notification to the computing device to enable provisioning of the computing device with the second content.

17. The method according to claim 10, further comprising:
detecting, at the back-end management unit, a second change in the location of the computing device such that the computing device transitions from the second location back to the first location;
in response to the detection of the second change in the location, generating a second provision notification associated with the second change in the location; and
forwarding the second provision notification to the computing device to enable provisioning of the computing device such that the computing device no longer has access to at least a portion of the second content.

18. The method according to claim 11, wherein forwarding the second provision notification further enables restoration of the first content or access to the first content at the computing device.

19. The method according to claim 10, wherein the first change in the location of the computing device is detected using location service coordinates, information from a communication network accessible to the computing device, or information from a social network or a scheduling tool.

20. The method according to claim 10, wherein the provisioning of the computing device includes modifying an application, data, or a setting at the computing device such that the computing device is configured to operate according to a language associated with the second location.
